(19) United States
(12) Patent Application Publication
(10) Pub. No.: US 2002/0007332 A1
(43) Pub. Date: Jan. 17, 2002

(54) Method and system for evaluation of potential funding sources for financial plans

(75) Inventors: Daniel R. Johnson, Boston, MA (US); Alok Mehta, Wellesley, MA (US)

Correspondence Address: David J. Thibodeau, Esq., HAMILTON, BROOK, SMITH & REYNOLDS, P.C., Two Militia Drive, Lexington, MA, 02421-4799, US

(73) Assignee: ASF-IP, Inc., Weston, MA (US)

(21) Appl. No.: 09/891,911

(22) Filed: Jun. 26, 2001

Related U.S. Application Data
(60) Provisional application No. 60/214,675, filed on Jun. 27, 2000.

(51) Int. Cl. G06F 17/60

(52) U.S. Cl. 705/36

(57) ABSTRACT

Embodiments of the invention include a system and method for comparing financial products as funding sources for a financial plan, such as a non-qualified supplemental benefit plan or an individual financial plan. Such embodiments include selecting two or more financial products for comparison of a set of attributes, assigning a weight to each of the attributes, scaling the values of the financial products across each attribute, multiplying the scaled values by the assigned weights, and generating a weighted score for each financial product by summing the weighted scaled values for each product. Various tradeoffs in selecting one product over another can be determined by changing the assigned weight for at least one of the attributes in a subsequent comparison.

### RELATED APPLICATION

This application claims the benefit of U.S. Provisional Application No. 60/214,675, filed on Jun. 27, 2000. The entire teachings of the above application are incorporated herein by reference.

### BACKGROUND OF THE INVENTION

Non-qualified benefit plans are executive benefit programs whose primary purpose is to provide supplemental benefits to a company's key executives. The term “supplemental” refers to additional benefits over and above the benefits provided by the company's qualified benefit plans (e.g., retirement, group life insurance, disability).

For example, Non-Qualified Deferral Plans (NQDP's) are a particular form of non-qualified benefit plan that permits a company's key executives to defer substantial portions of their compensation, thereby delaying taxation on both the deferral amount, and subsequent growth until the balance is distributed, as long as some basic rules are followed (e.g., exemptions from Employee Retirement Income Security Act of 1974 “ERISA” and from the constructive receipt doctrine under the Internal Revenue Code of 1986, as amended).

When a sponsor establishes a non-qualified benefit program, including a non-qualified deferral plan, the company is obliged to represent the commitment to distribute future benefits on their current balance sheet in the form of a liability. For an NQDP, the liability is equal to the aggregate account balances accrued for the participants.

During the accumulation period when participants are deferring receipt of current income, the company actually increases their after-tax cash flow by retaining the compensation they otherwise would have paid to the participants. As time passes, the value of the participants' accounts becomes significant.

Since non-qualified benefit plans are funded by the commitment of the employing entity (i.e., the “Plan Sponsor”), many companies elect to invest the retained compensation into a funding mechanism to accumulate assets to satisfy the future benefit obligation when it becomes due. While the company can invest in anything it wishes, two of the more popular choices are taxable securities (often held through Mutual Funds) or tax-sheltered Corporate Owned Life Insurance (COLI). Furthermore, some NQDP's use the values of such financial products as a means to define and measure the benefits of the plan.

In today's marketplace, there is significant competition among venders of financial products, with trade-offs associated with each product. For example, it is often true that companies with the best performing products may not have the highest ratings for financial strength. Similarly, a product with the lowest cash flow requirements may have relatively poor results with respect to impact on corporate earnings.

With the increase in product offerings and vendor competition, it has become more difficult for Plan Sponsors, designers, consultants, brokers, and administrators to differentiate among the financial options. There are a number of factors that must be evaluated in selecting an appropriate product to cover the future benefit obligation maximizing the total value to the company.

### SUMMARY OF THE INVENTION

Embodiments of the invention include a system and method for comparing financial products as funding sources for a financial plan, such as a non-qualified supplemental benefit plan or individual financial planning.

Two or more financial products are selected for comparison of a set of attributes. According to one embodiment, the products compared include life insurance policies (e.g., COLI insurance) and securities (e.g., mutual funds).

The attributes are populated with subjective or objective values for each product. Certain attributes are populated with grades from one or more financial databases, which provide a comparative grade of financial strength of product carriers. Such grades are typically provided as letter grades. Therefore, the grades are converted to a numeric scale. Other attributes are populated with values from a financial product illustration system, which projects values for each of the financial products. Still other attributes are populated with subjective scores from a user based upon the user's experience with similar plans, sponsors, and funding sources.

Each attribute is assigned a weight indicating its relevant importance in the product evaluation. The attributes are grouped into analytical categories (e.g., Financial Strength, Funding, Contractual Features, Other), with each category being assigned a weight. The sum of the weights of the individual attributes should be equal to the assigned weight of the analytical category.

The populated values or scores are scaled across each attribute in order to reduce clustering of values and to curve the grades for relative ranking purposes. According to one embodiment, the scores of each attribute are scaled by identifying a maximum value and a minimum value for an attribute, calculating an adjusted maximum value and an adjusted minimum value by applying a dispersion factor to the maximum and minimum values, calculating an adjusted range from the adjusted maximum and minimum values, and generating a scaled value from the adjusted range for each financial product, resulting in a curved set of scaled product values for the attribute.

Each of the scaled scores is then weighted by multiplying each score by an assigned weight. A weighted score for each financial product is generated by summing the weighted scaled values for each product. The resulting scores allow a user, such as a Plan Sponsor, designer, consultant, broker, or administrator, to differentiate among various product offerings. In order to compare various financial tradeoffs, the assigned weights can be modified in subsequent comparisons. Furthermore, changes may be made to the selected products and attributes to compare their effects on the relative rankings.

### BRIEF DESCRIPTION OF THE DRAWINGS

FIG. 1A is a set of pie charts illustrating weight assignment for analytical categories according to one embodiment.

FIG. 1B is a set of charts illustrating weight assignment for individual attributes within their analytical categories according to one embodiment.

FIG. 1C is a chart illustrating the overall, relative product scores resulting from the financial product evaluation according to one embodiment.

FIG. 2 is a diagram illustrating a financial product evaluation system according to one embodiment.

FIG. 3A is a flow chart illustrating the first stage for evaluating financial products as a potential funding source according to one embodiment.

FIG. 3B is a flow chart illustrating the second stage for evaluating financial products as a potential funding source according to one embodiment.

FIG. 4A illustrates the user interface as a spreadsheet according to one embodiment.

FIG. 4B is a conversion chart illustrating how rating agency grades map to a numeric scale according to one embodiment.

FIG. 4C illustrates the user interface as a spreadsheet after conversion of the rating agency grades into corresponding numeric scores according to one embodiment.

FIG. 4D illustrates the user interface as a spreadsheet calculating the adjusted range and adjusted maximum and minimum scores per attribute according to one embodiment.

FIG. 4E illustrates the resulting overall relative weighted product scores according to one embodiment.

FIG. 4F illustrates a different set of overall weighted product scores resulting from a reassignment of weights according to one embodiment.

FIGS. 5A-5M illustrate a web page interface for the AFS eValuator system according to one embodiment.

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

### DETAILED DESCRIPTION OF A PREFERRED EMBODIMENT

Embodiments of the invention include a system and method for evaluating financial products as a funding source for a financial plan, such as non-qualified supplemental benefit plans, individual financial plans, and other such types of financial plans. Such products may include securities (e.g., mutual funds) and life insurance (e.g., COLI insurance). In addition, other embodiments may evaluate financial products for individual financial planning and/or death benefit purposes.

Financial products are evaluated through a weighted scores comparison of a set of both subjective and objective attributes, referred to as comparison factors. Such attributes include financial or contractual attributes. Each of the attributes are grouped into analytical categories, such as Financial Strength, Funding Analysis, Contractual Features, and other such categories.

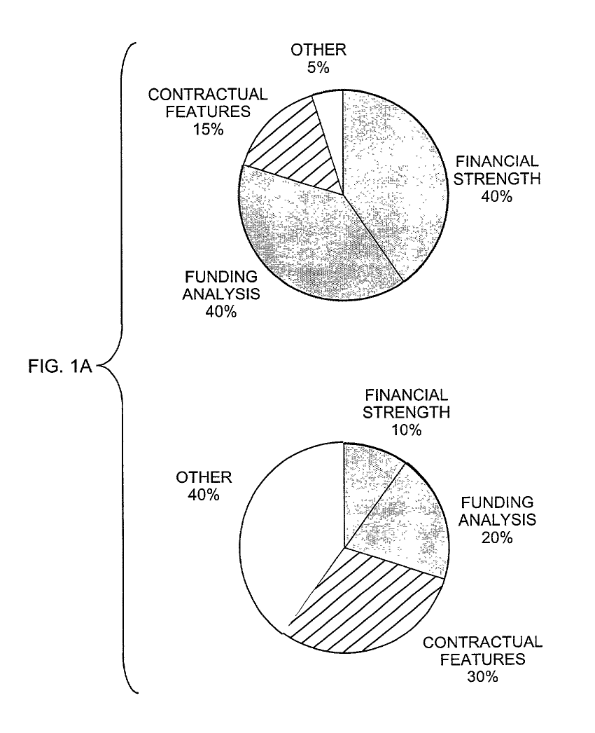

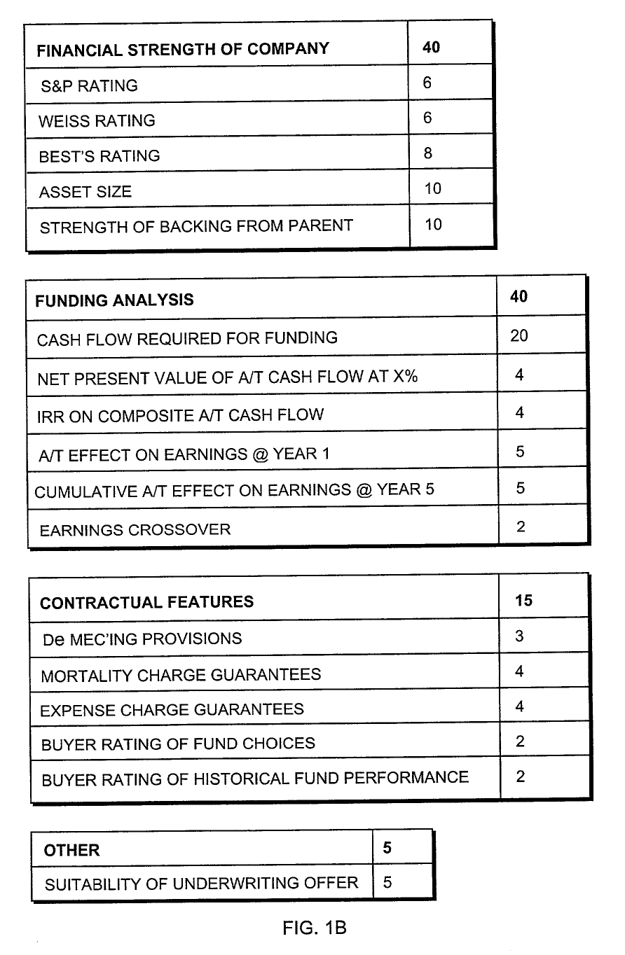

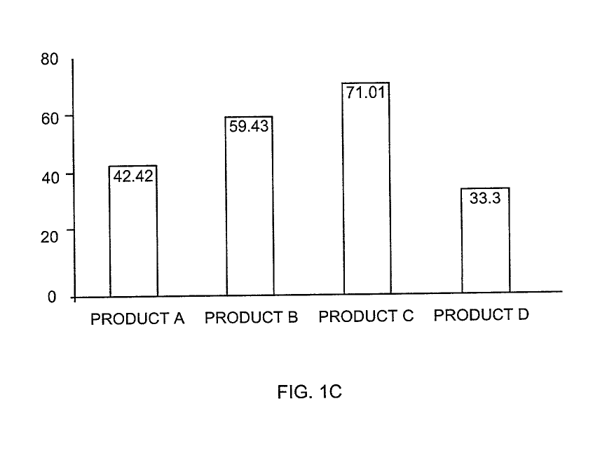

Each category is assigned a relative weight representing the relative importance of that category in analyzing product tradeoffs. FIG. 1A is a set of pie charts illustrating weight assignment for analytical categories according to one embodiment. The assigned weights can be changed in subsequent comparisons to evaluate the products in terms of alternate tradeoffs. Furthermore, each attribute within an analytical category is assigned a relative weight indicating its relative importance in a particular category. The sum of the weights of the individual attributes within a category should equal the assigned weight of the category, as illustrated in FIG. 1B.

The attributes are populated with subjective or objective values for each product. From the attribute values, an overall, relative product score and ranking is calculated for each product as illustrated in FIG. 1C. As the weights are changed, the resulting product scores may also change. If the product scores and rankings do not change substantially with changes in weight assignment, selecting the financial product with the highest overall scores is a robust decision. Conversely, substantial changes in the overall scores and rankings due to changes in weight assignment may highlight the tradeoffs in selecting one product over another. Thus, financial products may be evaluated with respect to various tradeoffs to determine how a supplemental benefit plan can best be optimized to maximize the total value to the company.

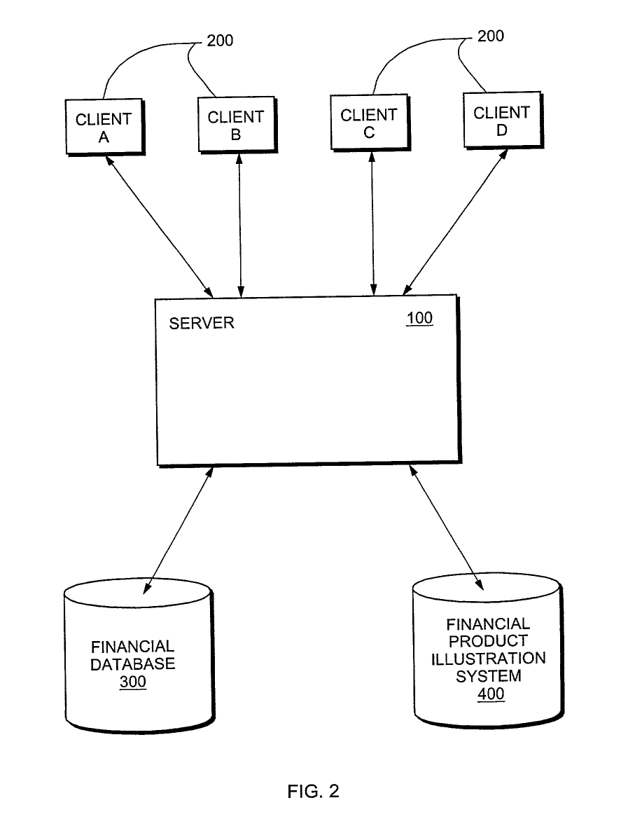

FIG. 2 is a diagram illustrating a financial product evaluation system according to one embodiment. The system includes a server 100, one or more clients 200, at least one financial database 300, and at least one financial product illustration system 400.

The server 100 includes an engine for evaluating a set of financial products according to the weighted scores analysis. Upon request, the server 100 generates and transmits an interactive graphic user interface (GUI) of the evaluation system to the one or more clients 200. The GUI allows a user to control selection of financial plan structure, selection of financial products under comparison, weight assignment, and input of subjective values for certain attributes. The server 100 may be implemented as a web server transmitting web pages for display on a client.

The clients 200 may be a computer, a kiosk, Personal Digital Assistant (PDA), hand-held computer, or any other network device capable of displaying interactive content (e.g., web browser). Other client-server arrangements are also possible. For example, the client-server configuration may be implemented at the same location as a spreadsheet according to another embodiment.

The server 100 retrieves data from the financial databases 300 and the illustration systems 400 to populate certain attributes for each product under comparison. The financial databases 300 include published financial information, such as organizational ratings of insurers and/or mutual funds. The illustration systems 400 calculate financial projections regarding the performance of various financial products over periods of time. According to one embodiment, the financial product illustration system 400 is the AFS Master System® by American Financial Systems, Inc., a Windows-based illustration, reprojection, and administration software system designed specifically for the supplemental benefits market.

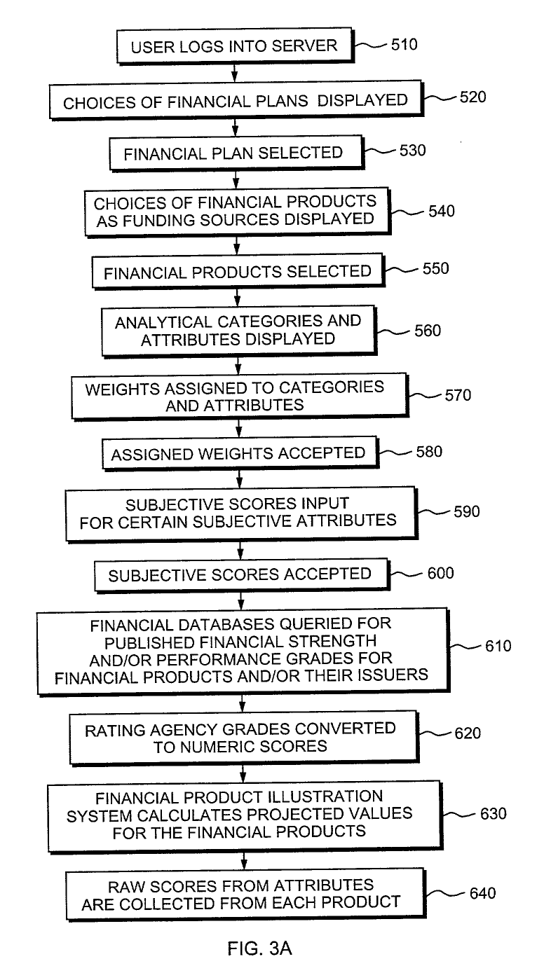

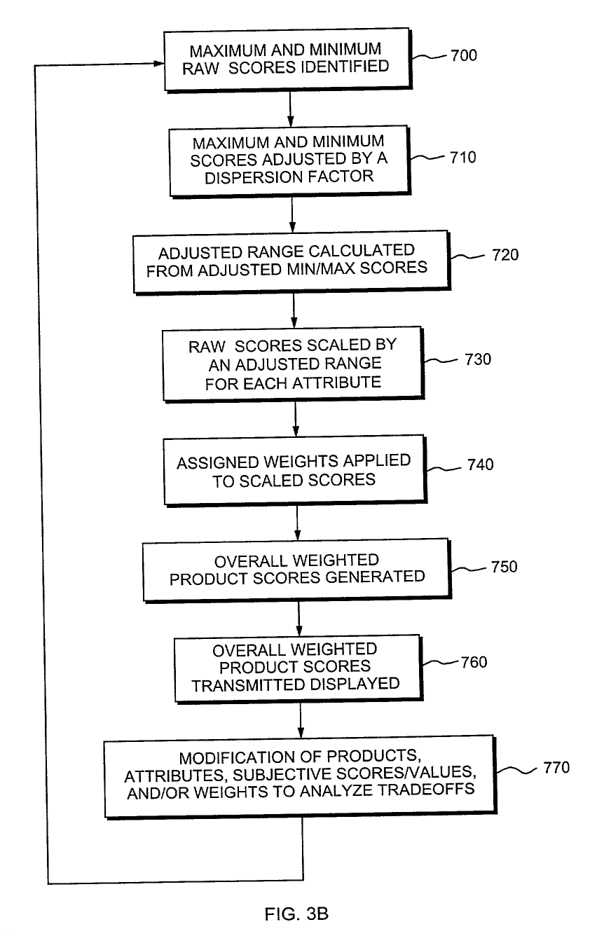

According to one embodiment, the process for comparing financial products includes a first stage for user input and raw scoring and a second stage for adjustment of scores and ranking. The process may be repeated as a user changes the products under comparison or the weights assigned to each category and attributes thereof. FIG. 3A is a flow chart illustrating the first stage, while FIG. 3B is a flow chart illustrating the second stage.

Referring to FIG. 3A, the user logs onto the server 100 from a client 200 at 510.

At 520, a graphical user interface is displayed through the client 200 with menus displaying choices of supplemental benefit plan structures.

At 530, the user selects the desired type of supplemental benefit plan structure. If the financial product evaluation is for funding an individual financial plan, the selection of supplemental benefit plan may be replaced with a selection of some other financial plan structure, if any.

At 540, a number of financial products are offered for the selected plan structure, typically corporate owned life insurance (COLI) or mutual funds. The system is capable of dynamically updating and supporting any number of products within the same broad category (e.g., COLI insurance or securities). Within a broad category, such as COLI insurance, the system can compare different financial products as funding sources having a wide range of contractual and other such features.

At 550, the user selects the financial products for evaluation as potential funding sources for the chosen type of supplemental benefit plan.

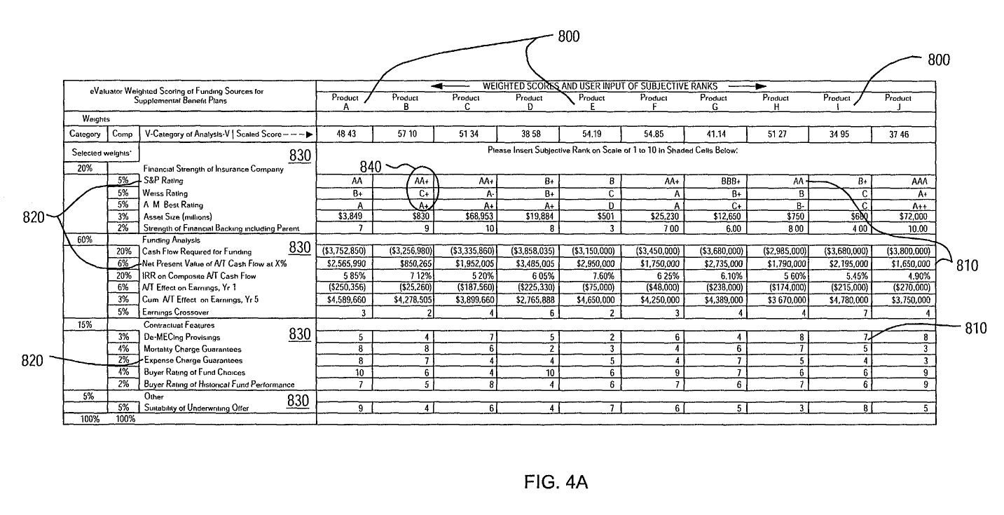

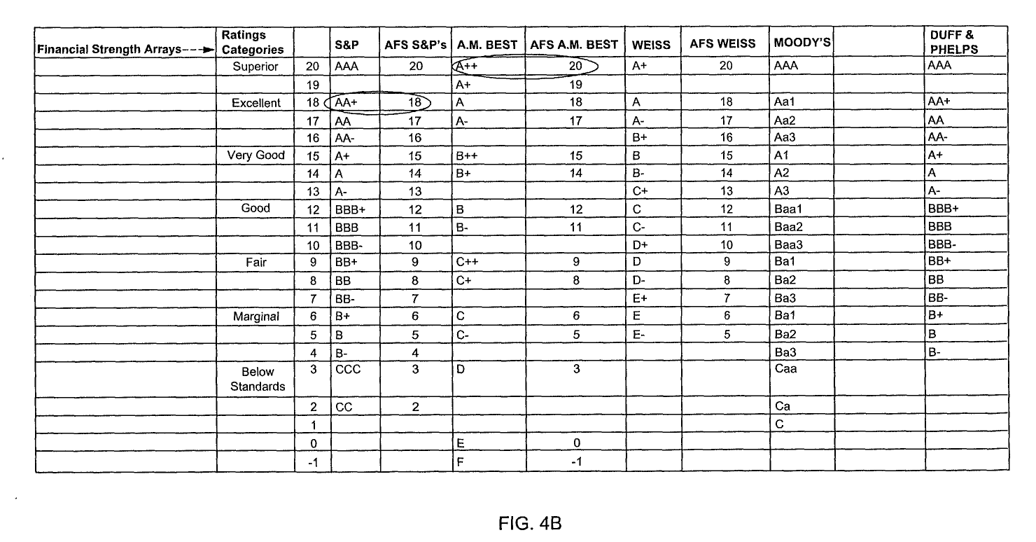

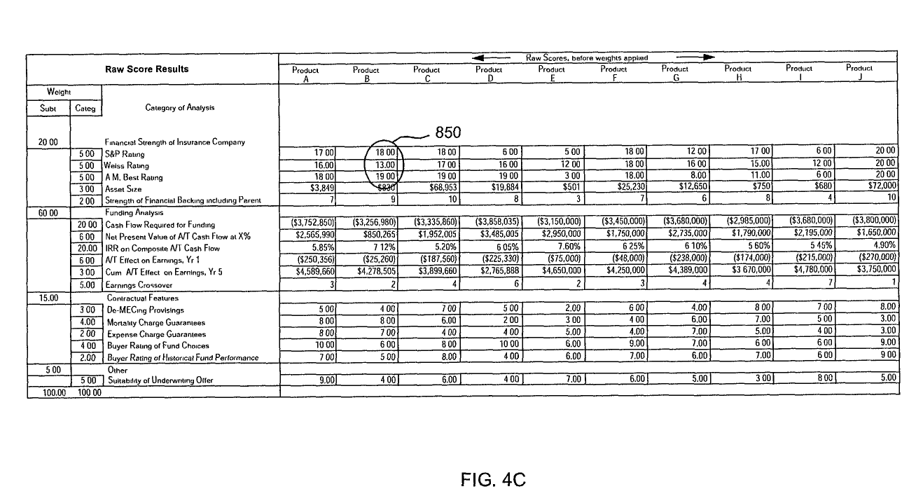

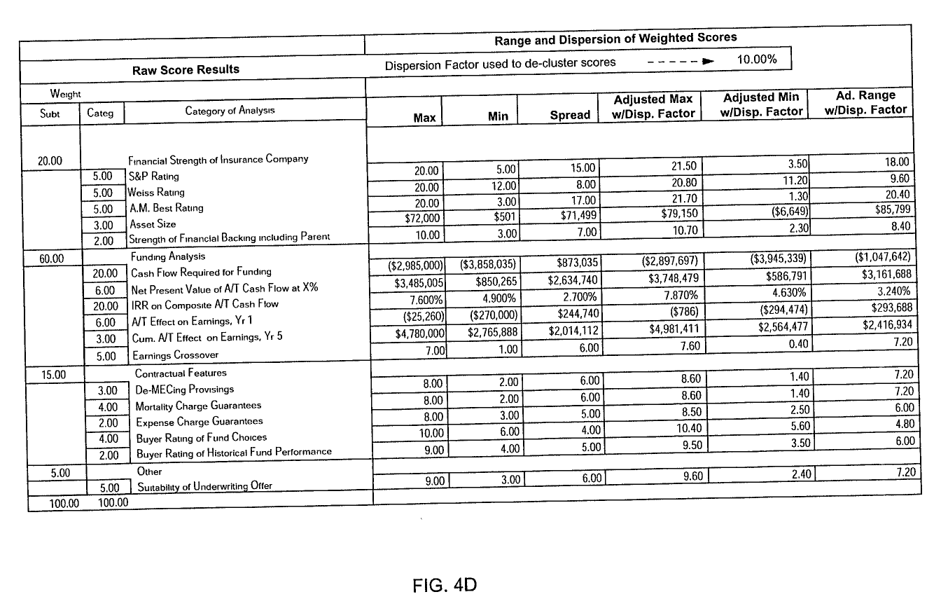

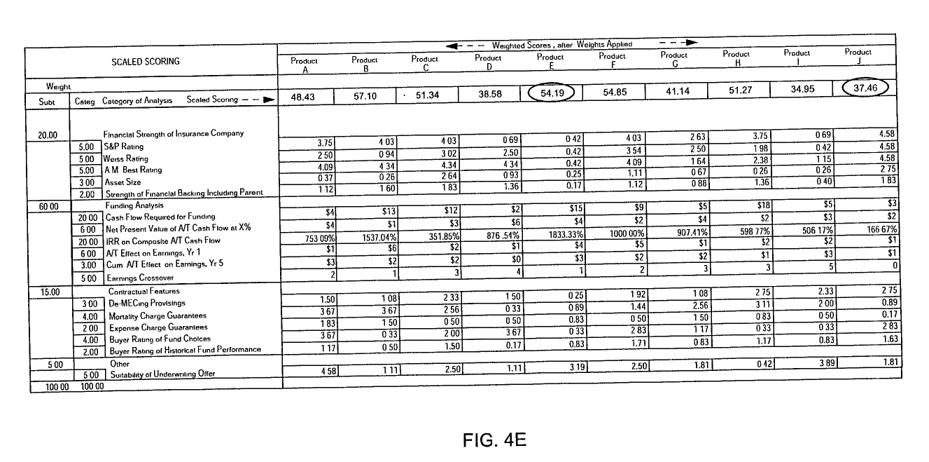

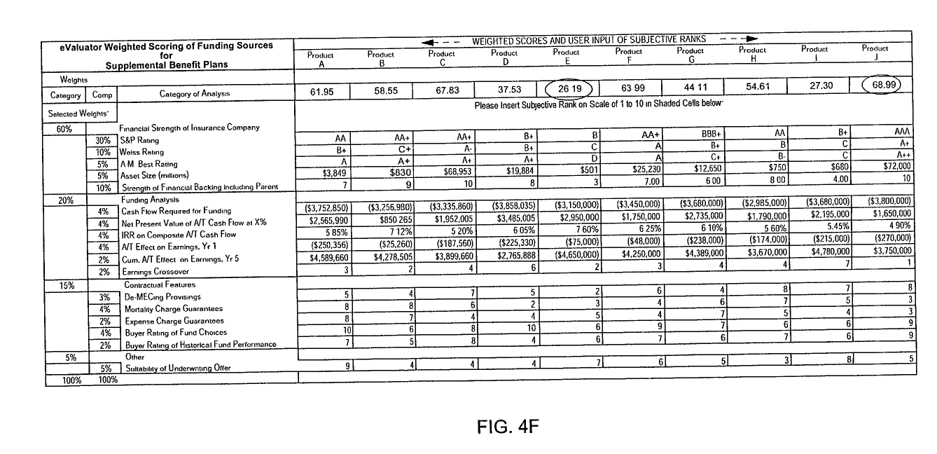

At 560 and referring to FIG. 4A, a user interface is displayed with the selected products 800 for the chosen plan and fields 810 corresponding to a set of attributes 820. These fields are populated either by user input or retrieval from the financial databases 300 and illustration systems 400. Sets of attributes are grouped into categories 830, such as (1) Financial Strength of Insurance Company, (2) Funding Analysis, (3) Contractual Features, and (4) Other.

At 570, the user assigns relative weights to each analytical category and to each attribute within each category. For example, in FIG. 4A, the “Funding Analysis” category is assigned the most weight (i.e., 60%), while the “Financial Strength” category is assigned less weight (i.e., 20%). Therefore, in this comparison, the plan administrator is evaluating the selected products, trading off financial strength for greater funding performance. The server 100 accepts the assigned weights at 580.

At 590, the user inputs subjective scores for the subjective attributes, which are accepted by the server 100 at 600.

At 610, the server 100 queries the financial databases 300 to populate certain objective attributes, such as rating agency grades under the “Financial Strength” category.

Referring to FIGS. 3A and 4A, the rating agency grades 840 published by organizational rating agencies, such as Standard and Poors (S&P), Weiss, and A.M. Best, are populated into the attribute input fields under the Financial Strength category that measure the adequacy of the issuer of a financial product (e.g., an insurance carrier) as a financial institution, which is covering a long term liability created by the non-qualified benefits that are being funded. Since these performance grades are typically specified as letter grades, the server 100 converts the financial strength performance grades into corresponding numeric scores 850 using a conversion chart at 620.

FIG. 4B is a conversion chart illustrating how rating agency grades map to a numeric scale according to one embodiment. According to one embodiment, the numeric scores for agency ratings range from −1 to 20. Since performance grades differ among agencies, a performance grade in one agency may not be given the same numeric score as the same performance grade in another agency. For example, a performance grade of AA+ from S&P maps to a numeric score of 18, while the same letter grade from A.M. Best maps to a numeric score of 20. FIG. 4C illustrates the user interface after conversion of the rating agency grades into corresponding numeric scores according to one embodiment.

At 630, the system launches and runs the financial product illustration software (e.g., AFS Master System® or other financial product illustration system) which may be executed on the same or different server as the server 100. The illustration system 400 calculates a variety of attributes, such as those under the “Funding Analysis” category for each potential funding source. The values of these attributes depend on the type of supplemental benefits plan selected and the particular products evaluated.

At 640, the server collects the raw scores of the attributes for each financial product for score adjustment and ranking.

FIG. 3B is a flow chart illustrating the second stage for evaluating financial products as a potential funding source according to one embodiment. In particular, the second stage involves the adjustment of scores and overall ranking.

At 700, the server 100 identifies a maximum raw score and a minimum raw score for each attribute from the set of scores collected from each product. For example, referring to FIGS. 4C and 4D, the maximum raw score for the S&P Rating attribute under Financial Strength is 20 for Product J, while the minimum raw score is 5 for Product E.

At 710, the maximum and minimum raw scores for each attribute are adjusted unless all scores are identical making adjustment irrelevant for relative ranking purposes. In particular, the maximum raw score and the minimum raw score for each attribute are adjusted by a dispersion factor. The dispersion factor is used to reduce clustering of scores and to curve the results of a particular attribute. The dispersion factor may be the same or different with each attribute. According to one embodiment, the adjusted maximum scores and adjusted minimum scores are calculated in accordance with equations 1 and 2 below:

Adjusted minimum score=Minimum raw score−(Spread×DF%) (1)

Adjusted maximum score=Minimum raw score+(Spread×(1+DF%)) (2)

where “Spread” is the difference between the maximum and minimum raw scores.

Referring to FIG. 4D, the dispersion factor (“DF%”) used in this embodiment is 10.00% for all attributes. For the S&P Rating attribute under Financial Strength, the spread used in the given example is 15.00. Thus, the adjusted minimum value is 3.50 (i.e., 5−(15×0.10)) for Product E, while the adjusted maximum value is 21.50 (i.e., 5+(15×(1+0.1))) for Product J.

At 720, an adjusted range is calculated by subtracting the adjusted minimum score from the adjusted maximum score. Referring to FIG. 4D, the adjusted range for the S&P Rating is 18.00 (i.e., 21.5−3.5).

At 730, the raw scores are scaled according to the adjusted range. According to one embodiment, the following equation is used to scale each of the raw scores for each attribute:

(Raw score−Adjusted minimum score)/Adjusted range (3)

For example, the scaled score of Product J for the S&P Rating attribute is approximately 0.9167 (i.e., (20−3.50)/18), while the scaled score for Product E is approximately 0.0833 (i.e., (5−3.50)/18). (not shown)

At 740, weighted scores for each attribute for each product are calculated by the product of the scaled scores and their assigned weight. For example, referring to FIG. 4E, the weighted score for Product J for the S&P Rating is approximately 4.58 (i.e., 5×0.9167), while the weighted score for Product E is approximately 0.42 (i.e., 5×0.0833).

At 750, the weighted scores of each product are summed together resulting in an overall relative score. For example, referring to FIG. 4E, Product J has an overall score of 37.46. Thus, out of ten financial products evaluated, Product J is ranked ninth overall, while Product E is ranked third.

At 760, the scaled scores and the funding source rankings are transmitted to the client 200 for graphical display.

At 770, the user receives the display of the results and may modify selections (e.g., weight assignment, user input values, product selection, etc) for recalculation of scores and rankings. As different funding sources are selected or removed, different weights assigned to categories and attributes, and/or different user input data specified, the overall relative product scores may change, highlighting the various tradeoffs associated with each product.

For example, in FIG. 4F, weight assignments were reversed for the Financial Strength and Funding Analysis categories. Similarly, the weights of the individual attributes within each category were modified to add up to their corresponding category. With these changes, Product J, which was originally ranked ninth out of ten products, is now ranked first with an overall weighted score of 68.99. Product E, which was ranked third in the original evaluation, is now ranked last. These evaluations illustrate that Product J has greater funding performance than the other products, but lacks financial strength as an insurer of the future obligation. Therefore, depending on the importance of such criteria, the plan administrator is able to differentiate between the various product offerings and make informed decisions with respect to financial tradeoffs.

The following paragraphs provide descriptions for the analytical categories and the individual attributes thereof according to one embodiment. However, one skilled in the art would realize that each analytical category and the attributes thereof may have more or less significance than another to a prospective purchaser, and that these attributes and categories may be modified to reflect different criteria of reference in particular countries or jurisdictions.

### Financial Strength

This general category provides measurements of the adequacy of the insurance carrier as a financial institution, which is covering a long term liability created by the non-qualified benefits that are being funded. The values or scores populating each of the following attributes are typically retrieved from financial databases 300.

(1) Organizational Ratings

The Rating Organizations, such as Standard & Poor's, Weiss, and A.M. Best, provide a quantitative comparative score of insurance carriers, measuring various criteria of financial strength, and ability to perform, according to each Rating Organization's standards. These three Organizations concern themselves with the carrier's overall financial strength, and their ability to meet policyholder obligations in the short and long term.

(2) Asset Size

Asset size generally indicates a carrier's maturity. For example, carriers that are well established and have existed for a good number of years, successfully accumulate an asset base by operating with good margins over a period of years. Asset size can be input by a user or a financial database 300 as objective data.

(3) Strength of Financial Backing including Parent

Policies are often issued through subsidiaries of a larger parent company. Some parent companies may contractually guarantee the solvency of, or provide funding to, the subsidiary, thereby making the parent company's financial strength a factor in the decision making process. Strength of Financial Backing is typically a user-specified ranking. Such scores typically range from 1 to 10.

### Funding Analysis

This general category compares the adequacy of the policies to be utilized as a funding vehicle according to six financial measures. Each financial measure may have more or less significance than another to a prospective purchaser, and these attributes (and related formulae) may be modified to reflect different criteria of reference in particular countries or jurisdictions. The values populating each of the following attributes are typically calculated and retrieved from financial product illustration systems 400.

(1) Cash Flow Required for Funding

The first year cash flow resulting from purchasing the insurance policies.

(2) Net Present Value of After-Tax Cash Flow at X%

The discounted value of the policy and benefits after-tax inflows and outflows at the user's selected discount rate. The greater the number, the more superior the policy as a funding vehicle.

(3) Internal Rate of Return (IRR) on Composite After-Tax Cash Flow

The internal rate of return on the policy and benefits after-tax inflows and outflows. The IRR represents the annual discount rate at which the present value of after-tax inflows equals after-tax outflows. The greater the IRR, the more superior the policy as a funding vehicle.

(4) After-Tax Effect on Earnings at end of First Plan Year

The after-tax effect on the purchaser's P&L (Earnings) Statement projected to result from the policy and benefits in the first year of the program. Generally, the smaller the earnings effect, the more attractive the policy is considered as a funding vehicle by the purchaser.

(5) Cumulative After-Tax Effect at end of Fifth Plan Year

The cumulative after-tax effect on the purchaser's P&L (Earnings) Statement projected to result from the policy and benefits through the first five years of the program. Generally, the smaller the earnings effect, the more attractive the policy is considered as a funding vehicle by the purchaser.

(6) Earnings Crossover

The first year the cumulative after-tax effect on the purchaser's P&L (Earnings) Statement is projected to become positive. Generally, the earlier the year, the more attractive the policy is considered as a funding vehicle.

### Contractual Features

Policies may contain a variety of internal features that may be considered important in their selection as a funding vehicle to cover future long-term liabilities. The values or scores populating each of the following attributes are typically user-specified ranked scores specified by the user of the system.

(1) De-MECing Provisions

For COLI-funded plans whose Plan Sponsors and/or participants are affected by United States Income Tax, it is important to avoid a policy becoming a MEC (Modified Endowment Contract) as a result of policy withdrawals and/or loans exceeding certain formulaic limits.

The de-MECing provisions in an insurance policy illustrate the strength of the policy in terms of its compliance with modified endowment contract rules under the Internal Revenue Code, so that withdrawals of cash value will be treated first as a return of basis rather than a return on earnings. In other words, withdrawals are taxed on a first-in/first-out basis rather than a last-in/first-out basis.

The most straightforward method of avoiding MEC status is to increase the face amount. Some policies contain the contractual right to increase face amount, without evidence of insurability, to the level necessary to avoid MEC status.

(2) Mortality Charge Guarantees

Mortality charge levels are a significant component of policy performance. Some policies contain a provision that the current level of mortality charges will not be increased for a specified number of years. Others contain ceilings on the magnitude of the potential increase, while others may base the mortality charges on the purchaser's actual experience, (i.e., “experience rate”).

(3) Expense charge Guarantees

Premium loads, flat and per $1,000 of insurance expense charges are often guaranteed by contract not to increase, thus resulting in long term projections of performance being more reliable.

(4) Buyers Rating of Fund Choices

Variable contracts offer a variety of investment choices. The number of finds available and the nature of funds available (e.g., stock—large cap, mid cap, small cap, indexed; bonds—short term, long term; money market) could affect the decision to purchase, because supplemental benefit plans may be measured by, and the adequacy of the funding source will be affected by, the cash value of the funding source, which is determined by the performance of its underlying securities.

(5) Buyers Rating of Historical Fund Performance

Historical performance is often a consideration in the decision to purchase an investment oriented product. Embodiments of the invention utilize various industry measures in determining the raw score for historical performance. Large and mid-cap stock funds are measured against the S&P 500 and S&P 400, respectively. Small cap stock funds are measured against the Russell 2000 Stock Index. Other indices may be used as well.

### Other

(1) Suitability of Underwriting Offer

For example, the terms on which the COLI insurance coverage is committed versus the underwriting requirements and conditions imposed for life insurance coverage of plan participants.

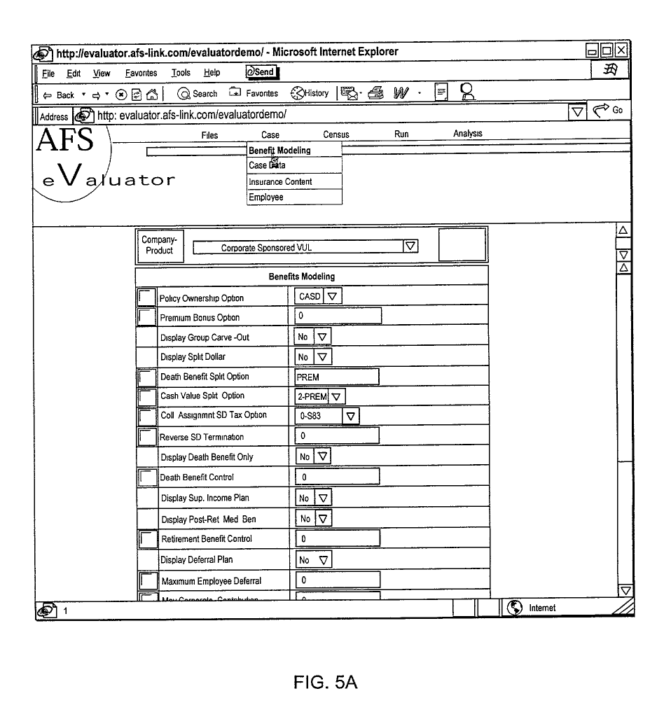

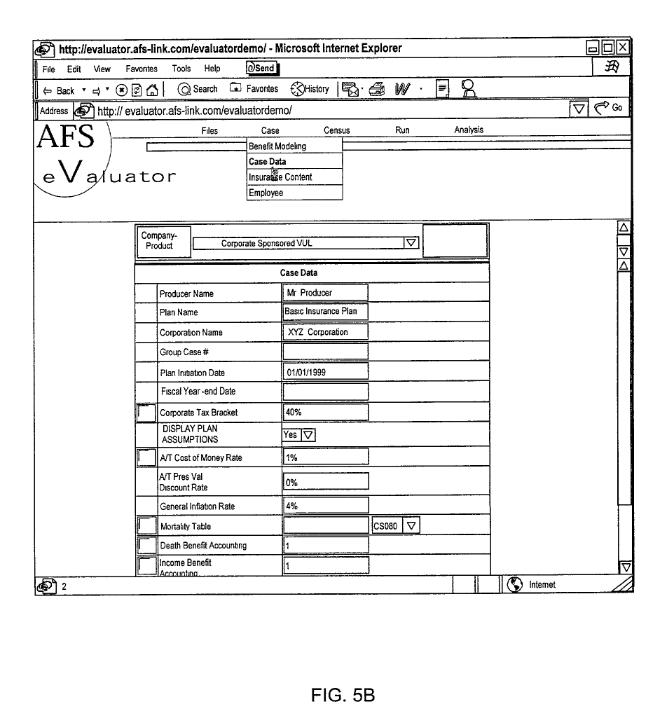

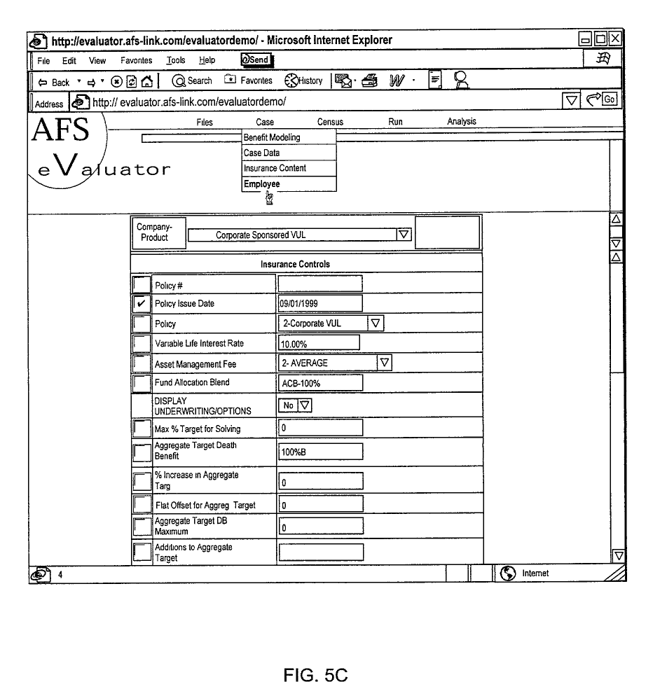

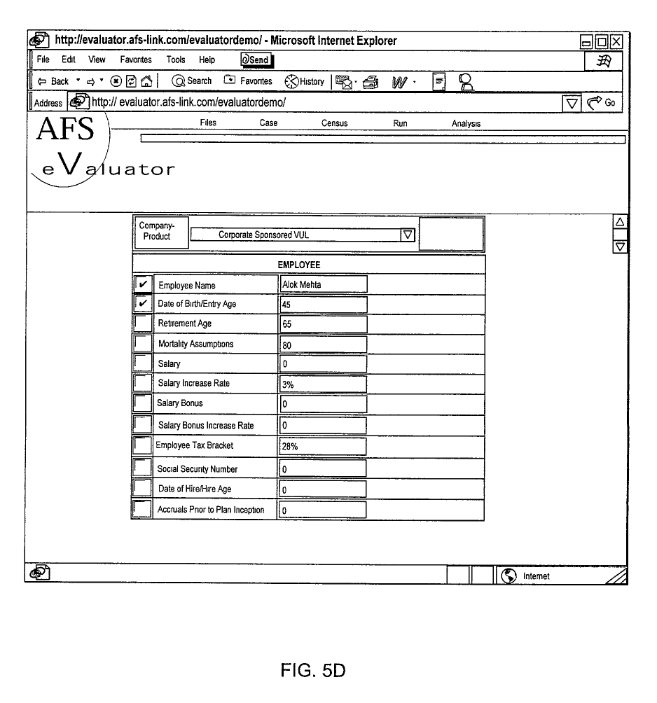

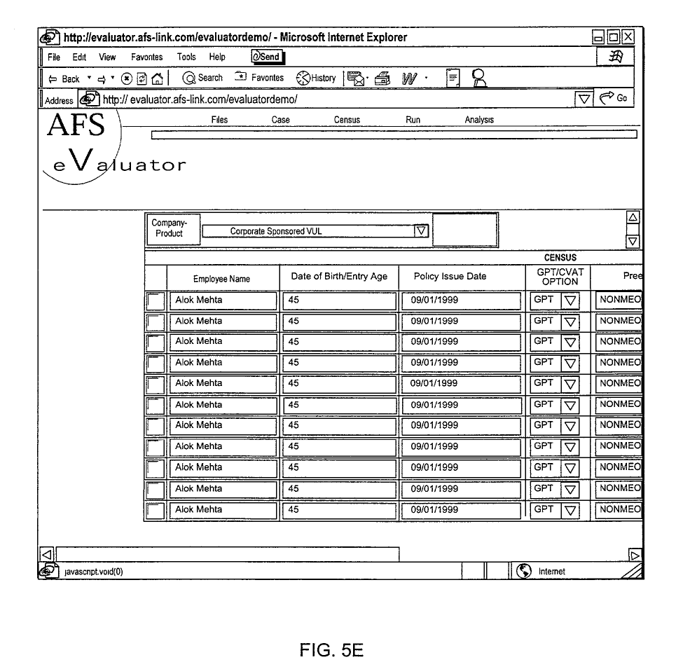

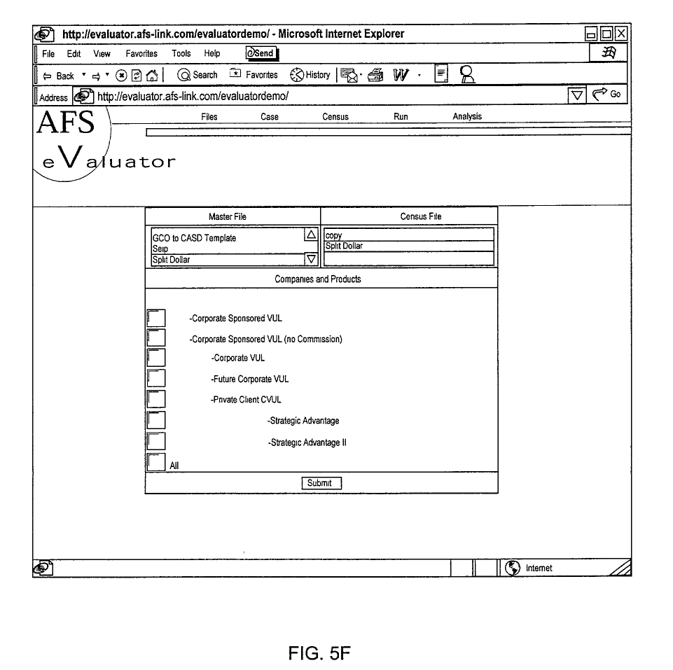

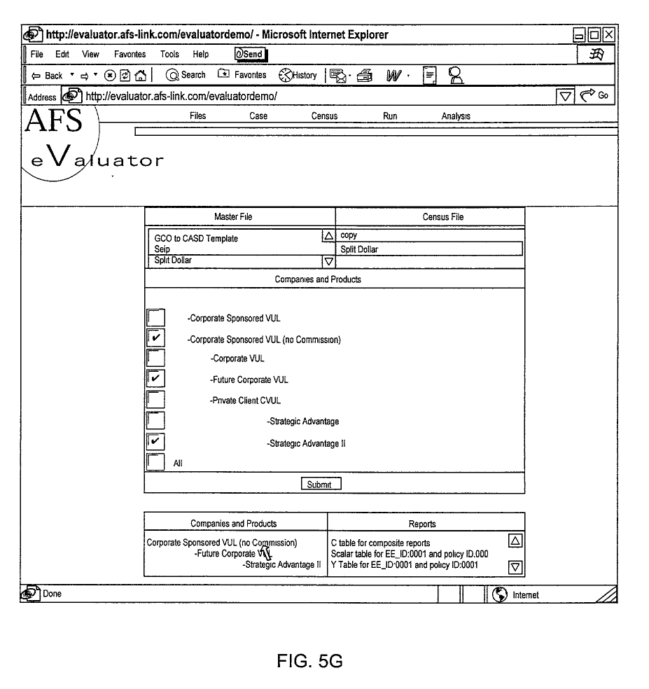

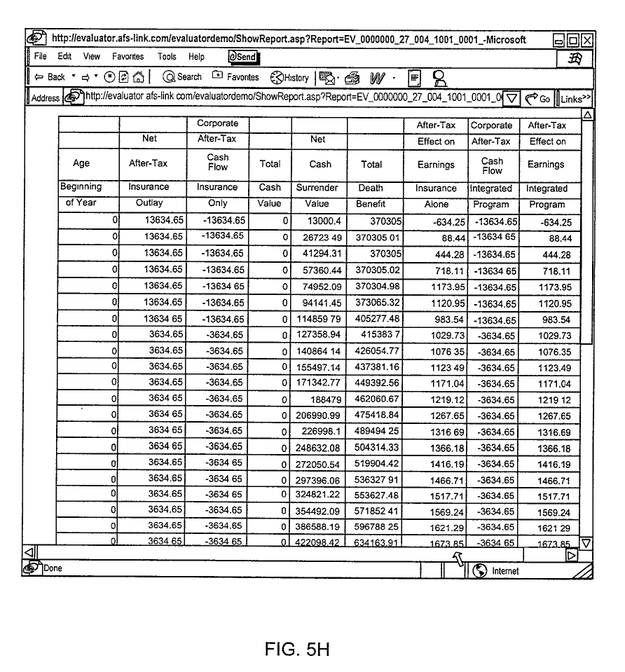

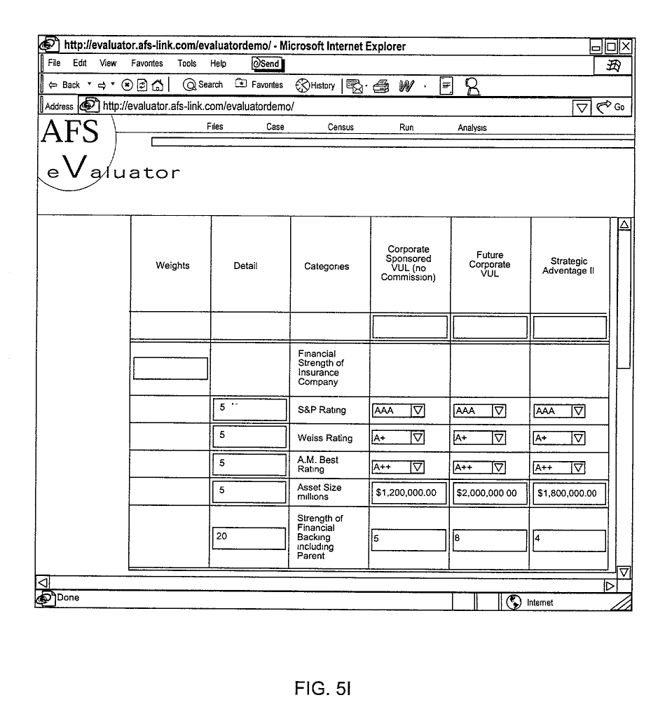

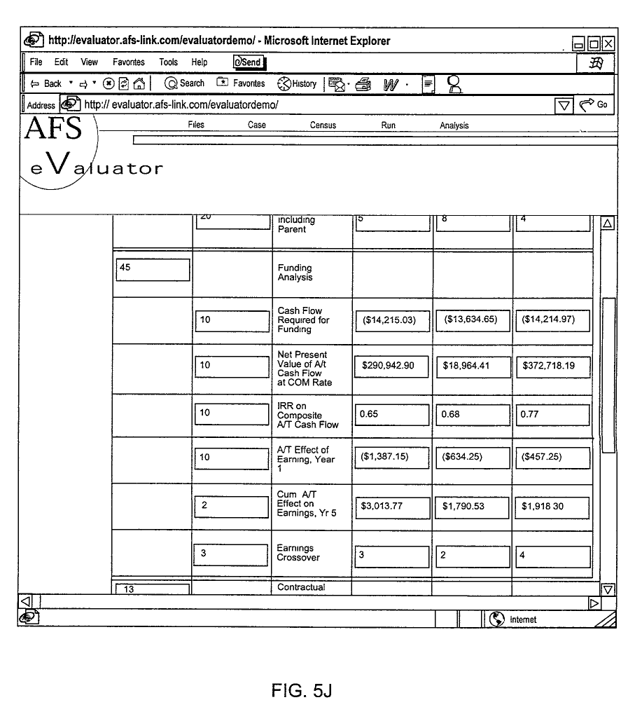

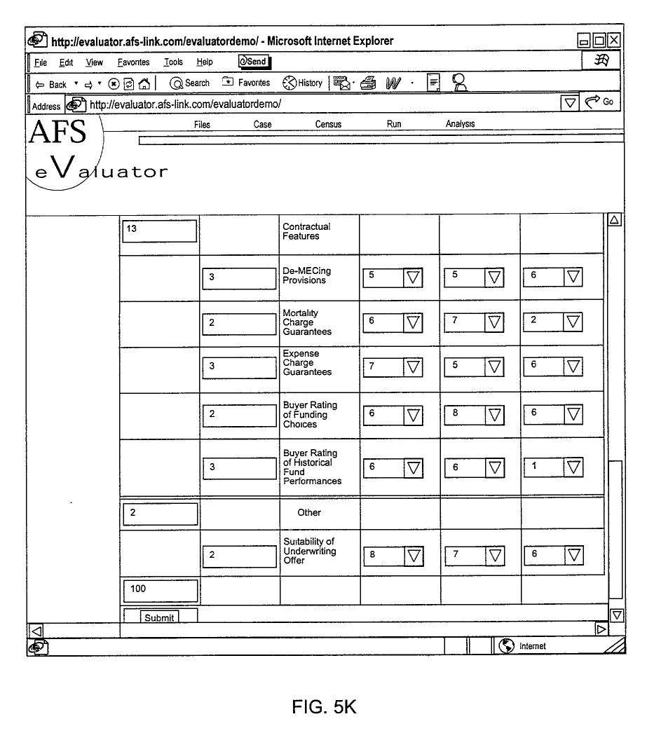

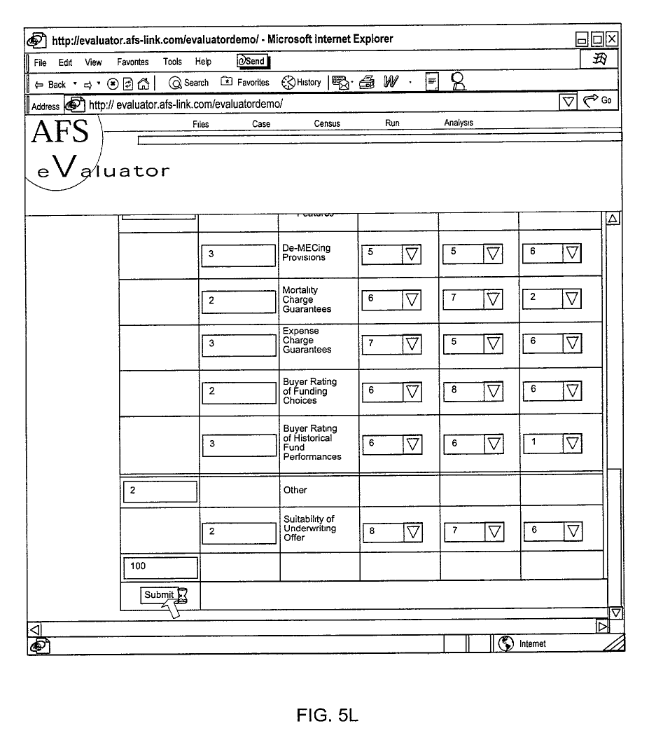

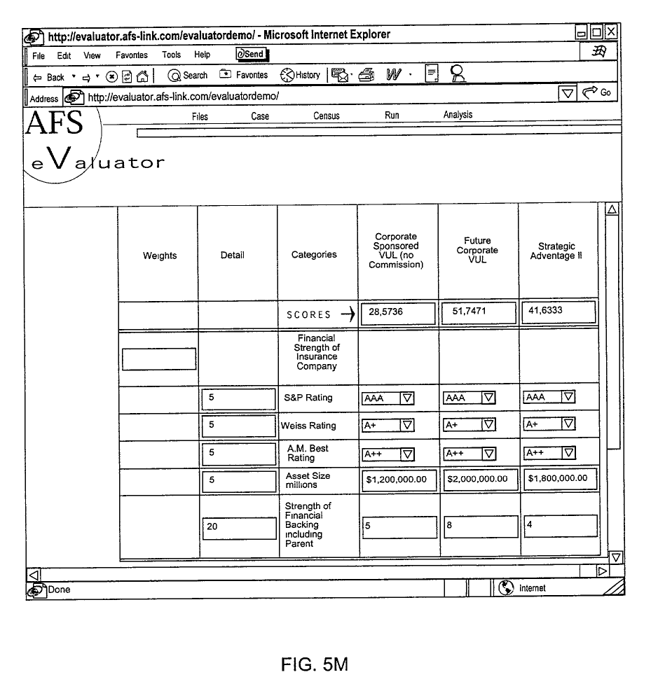

As discussed with respect to FIG. 2, embodiments of the invention may communicate with a user through an interactive web page interface. AFS eValuator by American Financial Systems, Inc. is a particular embodiment that evaluates potential funding sources for non-qualified supplemental benefit plans. FIGS. 5A-5M illustrate the web page interface for the AFS eValuator system according to one embodiment.

FIG. 5A is a web page interface for controlling benefits modeling. Through this interface, a user can specify various options and/or parameters for tailoring a financial product according to the requirements of a particular benefit plan. In this example, the financial product is a corporate sponsored variable universal life insurance (VUL) policy. The parameters may change for different financial product types, such as mutual funds or other types of insurance products.

FIG. 5B is a web page interface for specifying particular case data. Through this interface, a user can specify certain parameters that may be included in the projection of values in the funding analysis of a financial product for a particular benefit plan. Again, the parameters of the case data may change depending on the plan and product selected.

Referring to FIG. 5C where the financial product is a life insurance product, a web page interface facilitates the specification of relevant insurance controls for the product tailored to the particular benefit plan.

FIG. 5D is a web page interface through which employee census data is input for a participant of the particular benefit plan, while FIG. 5E is a web page interface displaying employee census data for all participants in the plan.

FIG. 5F is a web page interface displaying a list of financial products available as potential funding sources for a selected benefit plan and employee census data, while FIG. 5G is the web page interface upon user selection of two or more of the available products. In the lower table of FIG. 5G, related projection reports are available for viewing as well. These reports can provide information to assist a user in assigning scores to subjective attributes and in assigning weights to attributes and analytical categories.

FIG. 5H is a web page interface for a report displaying projected data generated by an underlying illustration program, such as the AFS Master System®. In this display, the data projected is for a particular insurance policy providing finds for the selected benefit plan and applicable employee census data.

FIGS. 51-5K are portions of a web page interface displaying the list of attributes within the analytical categories of Financial Strength of Insurance Company, Funding Analysis, Contractual Features, and Other. Each category and attribute thereof is assigned a weight for analyzing various financial and contractual tradeoffs. The user is initially presented with default rankings, but these can be changed according to the user's preference. Each financial product selected for comparison (e.g., Corporate Sponsored VUL—no commision; Future Corporate VUL; and Strategic Advantage II) contains values for each attribute. Some attributes are automatically populated with values from the AFS Master System® or financial database, while other attribute values are user-specified, based on the user's experience with similar products and plans. The weights and attribute values can be altered through this interface in subsequent comparisons. Once the weights and attributes are populated with values, the weighted scores analysis is initiated by the user clicking on a “Submit” button, as illustrated in FIG. 5L.

FIG. 5M is a web page interface displaying the resulting scores from the weighted scores analysis with the weights selected by the user. For example, in FIG. 5M, the financial product named Future Corporate VUL has the highest product score of the compared products according to the set of weighted categories and attributes. However, these values and rankings may change if there are tradeoffs between products as illustrated with respect to FIG. 4F. In addition, an online report of the results of the analysis may be provided through a web page interface for user records.

Those of ordinary skill in the art realize that methods involved in a system and method for evaluation of potential funding sources for financial plans, such as non-qualified supplemental benefit plans, may be embodied in a computer program product that includes a computer-usable medium. For example, such a computer usable medium can include a readable memory device, such as a hard drive device, a CD-ROM, a DVD-ROM, a computer diskette or solid-state memory components (ROM, RAM), having computer readable program code segments stored thereon. The computer readable medium can also include a communications or transmission medium, such as a bus or a communications link, either optical, wired, or wireless, having program code segments carried thereon as digital or analog data signals.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for comparing financial products as funding sources for a financial plan, comprising:
selecting two or more financial products for comparison of a set of attributes, each financial product having values corresponding to the set of attributes;
assigning a weight to each of the attributes;
scaling the values of the financial products across each attribute;
multiplying the scaled values by the assigned weights; and
generating a weighted score for each financial product by summing the weighted scaled values for each product.

2. The method of claim 1, further comprising:
changing the assigned weight for at least one of the attributes to compare financial tradeoffs.

3. The method of claim 1, wherein scaling the values for each attribute further comprises:
identifying a maximum value and a minimum value for an attribute;
calculating an adjusted maximum value and an adjusted minimum value by applying a dispersion factor to the maximum and minimum values;
calculating an adjusted range from the adjusted maximum and minimum values; and
generating a scaled value from the adjusted range for each financial product resulting in a curved set of scaled product values for the attribute.

4. The method of claim 1, further comprising:
populating one or more of the attributes for the financial products with grades from one or more financial databases, the databases providing a comparative grade of financial strength of financial product carriers; and
converting the grades into numeric values.

5. The method of claim 1, further comprising:
populating one or more of the attributes of the financial products with values from a financial product illustration system, the system projecting values of each of the financial products.

6. The method of claim 1, further comprising:
populating one or more of the attributes of the financial products with subjective scores from a user.

7. The method of claim 1, wherein the set of attributes are grouped into categories and further comprises assigning a weight to each of the categories.

8. The method of claim 7, wherein a summation of the weights of the attributes within a category is equal to the assigned weight of the category.

9. The method of claim 7, where in the categories comprise financial strength, funding, contractual features.

10. The method of claim 9, wherein the attributes within the financial strength category include:
at least one rating from a rating agency;
asset size; and
strength of financial backing including parent.

11. The method of claim 9, wherein the attributes within the funding category include:
first year cash flow resulting from purchasing a particular policy;
discounted value of the policy and benefits after tax cash flow at a discounted rate;
internal rate of return on policy and benefits after tax cash flow;
after-tax effect on earnings due to the policy and benefits in first year;
cumulative after-tax effect on earnings due to the policy and benefits through first five years; and
number of years until the cumulative after-tax effect on earnings becomes positive.

12. The method of claim 9, wherein the attributes within the contractual features category include:
de-MECing provisions;
mortality charge guarantees;
expense charge guarantees;
buyers rating of fund choices; and
buyers rating of historical fund performance.

13. The method of claim 9, the attributes include suitability of underwriting offer.

14. The method of claim 1, further comprising:
selecting a non-qualified supplemental benefits plan, the two or more financial products compared for funding the plan.

15. The method of claim 1, wherein the two or more financial products are compared for individual financial planning.

16. The method of claim 1, wherein the two or more financial products compared include life insurance policies.

17. The method of claim 16, wherein the life insurance policies include corporate-owned life insurance policies.

18. The method of claim 1, wherein the two or more financial products compared include securities.

19. The method of claim 18, wherein the securities include mutual funds.

20. A system for comparing financial products as funding sources for a financial plan, comprising:
a server;
one or more clients in communication with the server;
the one or more clients selecting two or more financial products for comparison of a set of attributes by the server, the server retrieving values for each financial product corresponding to the set of attributes;
the one or more clients assigning a weight to each of the attributes;
the server scaling the values of the financial products across each attribute;
the server multiplying the scaled values by the assigned weights; and
the server generating a weighted score for each financial product by summing the weighted scaled values for each product.

21. The system of claim 20, further comprising:
the one or more clients changing the assigned weight for at least one of the attributes to compare financial tradeoffs.

22. The system of claim 20, wherein the scaling of the values by the server for each attribute further comprises:
the server identifying a maximum value and a minimum value for an attribute;
the server calculating an adjusted maximum value and an adjusted minimum value by applying a dispersion factor to the maximum and minimum values;
the server calculating an adjusted range from the adjusted maximum and minimum values; and
the server generating a scaled value from the adjusted range for each financial product resulting in a curved set of scaled product values for the attribute.

23. The system of claim 20, further comprising:
one or more financial databases;
the server populating one or more of the attributes of the financial products with grades from the one or more financial databases, the one or more financial databases providing a comparative grade of financial strength of financial product carriers; and
converting the grades into numeric values.

24. The system of claim 20, further comprising:
one or more financial product illustration systems; and
the server populating one or more of the attributes of the financial products with values from the one or more financial product illustration systems, the systems projecting values of each of the financial products.

25. The system of claim 20, further comprising:
the server populating one or more of the attributes of the financial products with subjective scores from a client.

26. The system of claim 20, wherein:
the server groups the set of attributes into categories; and
the one or more clients assign a weight to each of the categories.

27. The system of claim 26, wherein a summation of the weights of the attributes within each of the categories is equal to the assigned weight of the category.

28. The system of claim 26, wherein the categories comprise financial strength, funding, contractual features.

29. The system of claim 28, wherein the attributes within the financial strength category include:
at least one rating from a rating agency;
asset size; and
strength of financial backing including parent.

30. The system of claim 28, wherein the attributes within the funding category include:
first year cash flow resulting from purchasing a particular policy;
discounted value of the policy and benefits after tax cash flow at a discounted rate;
internal rate of return on policy and benefits after tax cash flow;
after-tax effect on earnings due to the policy and benefits in first year;
cumulative after-tax effect on earnings due to the policy and benefits through first five years; and
number of years until the cumulative after-tax effect on earnings becomes positive.

31. The system of claim 28, wherein the attributes within the contractual features category include:
de-MECing provisions;
mortality charge guarantees;
expense charge guarantees;
buyers rating of fund choices; and
buyers rating of historical fund performance.

32. The system of claim 28, the attributes further include suitability of underwriting offer.

33. The system of claim 20, further comprising:
the one or more clients selecting a non-qualified supplemental benefits plan, the two or more financial products compared for funding the plan.

34. The system of claim 20, wherein the one or more clients comparing the two or more financial products for individual financial planning purposes.

35. The system of claim 20, wherein the two or more financial products compared include life insurance policies.

36. The system of claim 35, wherein the life insurance policies include corporate-owned life insurance policies.

37. The system of claim 20, wherein the two or more financial products compared include securities.

38. The system of claim 37, wherein the securities include mutual funds.

39. An article of manufacture, comprising:
a computer-usable medium;
a set of computer operating instructions embodied on the medium, including instructions for a method of comparing financial products as funding sources for a financial plan, comprising instructions for:
selecting two or more financial products for comparison of a set of attributes, each financial product having values corresponding to the set of attributes;
assigning a weight to each of the attributes;
scaling the values of the financial products across each attribute;
multiplying the scaled values by the assigned weights; and
generating a weighted score for each financial product by summing the weighted scaled values for each product.

40. The article of claim 39, further comprising instructions for changing the assigned weight for at least one of the attributes to compare financial tradeoffs.

41. The article of claim 39, wherein the instructions for scaling the values for each attribute further comprises:
identifying a maximum value and a minimum value for an attribute;
calculating an adjusted maximum value and an adjusted minimum value by applying a dispersion factor to the maximum and minimum values;
calculating an adjusted range from the adjusted maximum and minimum values; and
generating a scaled value from the adjusted range for each financial product resulting in a curved set of scaled product values for the attribute.

42. The article of claim 39, further comprising instructions for:
populating one or more of the attributes of the financial products with grades from one or more financial databases, the databases providing a comparative grade of financial strength of financial product carriers; and
converting the grades into numeric values.

43. The article of claim 39, further comprising instructions for populating one or more of the attributes of the financial products with values from a financial product illustration system, the system projecting values of each of the financial products.

44. The article of claim 39, further comprising instructions for populating one or more of the attributes of the financial products with subjective scores from a user.

45. The article of claim 39, further comprising instructions for:
grouping the set of attributes into categories; and assigning a weight to each of the categories.

46. The article of claim 45, wherein the categories comprise financial strength, funding, contractual features.

47. The article of claim 45, wherein the attributes within the financial strength category include:
at least one rating from a rating agency;
asset size; and
strength of financial backing including parent.

48. The article of claim 45, wherein the attributes within the funding category include:
first year cash flow resulting from purchasing a particular policy;
discounted value of the policy and benefits after tax cash flow at a discounted rate;
internal rate of return on policy and benefits after tax cash flow;
after-tax effect on earnings due to the policy and benefits in first year;
cumulative after-tax effect on earnings due to the policy and benefits through first five years; and
number of years until the cumulative after-tax effect on earnings becomes positive.

49. The article of claim 45, wherein the attributes within the contractual features category include:
de-MECing provisions;
mortality charge guarantees;
expense charge guarantees;
buyers rating of fund choices; and
buyers rating of historical fund performance.

50. The article of claim 45, the attributes include suitability of underwriting offer.

51. The article of claim 39, further comprising instructions for selecting a non-qualified supplemental benefits plan, the two or more financial products compared for funding the plan.

52. The article of claim 39, wherein the two or more financial products are compared for individual financial planning purposes.

53. The article of claim 39, wherein the two or more financial products compared include life insurance policies.

54. The article of claim 53, wherein the life insurance policies include corporate-owned life insurance policies.

55. The article of claim 39, wherein the two or more financial products compared include securities.

56. The article of claim 55, wherein the securities include mutual funds.
